(19) United States
(12) Patent Application Publication
(10) Pub. No.: US 2014/0054171 A1
(43) Pub. Date: Feb. 27, 2014

(54) Analyte Sensor Utilizing Oxygen as Oxidant

(71) Applicant: Abbott Diabetes Care Inc., (US)

(72) Inventors: Benjamin J. Feldman, Oakland, CA (US); Lam N. Tran, Vallejo, CA (US); Zenghe Liu, Alameda, CA (US); Yi Wang, San Ramon, CA (US)

(73) Assignee: ABBOTT DIABETES CARE INC., Alameda, CA (US)

(21) Appl. No.: 13/767,350

(22) Filed: Feb. 14, 2013

Related U.S. Application Data
(60) Provisional application No. 61/601,401, filed on Feb. 21, 2012.

(51) Int. Cl. G01N 27/327

(52) U.S. Cl. CPC G01N 27/3272
USPC 204/403.14

(57) ABSTRACT

An analyte sensor configured to utilize oxygen as an oxidant and method for manufacturing and using the same are provided. The analyte sensor includes a catalyst to facilitate use of oxygen as oxidant. The catalyst may be provided on an electrode of the analyte sensor.

### CROSS-REFERENCE TO RELATED APPLICATIONS

This application claims priority based on U.S. Provisional Application No. 61/601,401, filed Feb. 21, 2012, the disclosure of which is incorporated by reference herein.

### INTRODUCTION

Analyte sensors are routinely used to monitor body fluids of a subject to detect presence of analytes of interest and also to determine concentration of analytes of interest.

Analyte sensors may be configured to conduct an electrochemical or optical analysis of an analyte using an analyte specific enzyme to oxidize or reduce the analyte and generate a signal proportional to the concentration of the analyte.

The performance of analyte sensors can be optimized by changing configurations of certain components of the analyte sensor as well as by decreasing the variation introduced by the manufacturing process.

As such, there in an interest in analyte sensors that provide accurate analyte concentrations and have reduced batch to batch variation as a result of simplified production process.

### SUMMARY

An analyte sensor configured to utilize oxygen as an oxidant and method for using the same are provided. The analyte sensor includes a catalyst to facilitate use of oxygen as oxidant. The catalyst may be provided on an electrode of the analyte sensor.

Embodiments of the present disclosure relate to an analyte sensor for analyzing an analyte, the analyte sensor comprising a first electrode including an enzyme specific for the analyte and a redox mediator and a second electrode comprising a catalyst for reducing oxygen, wherein the catalyst mediates transfer of electrons from the analyte to oxygen.

As noted above, the analyte sensor includes a catalyst for facilitating transfer of electrons generated by oxidation of an analyte (e.g., glucose or ketone) to oxygen. In some embodiments, the catalyst may be platinum. In certain embodiments, the catalyst comprises platinized carbon.

In certain embodiments, a redox mediator included in the sensors as disclosed herein has a formal redox potential in the range of about −200 mV to about +200 mV versus Ag/AgCl in physiological condition (0.1M NaCl, pH 7). For example, the redox mediator has a formal potential negative of +200 mV versus Ag/AgCl in 0.1M NaCl, pH 7. In certain cases, the redox mediator has a formal potential negative of +100 mV versus Ag/AgCl in 0.1M NaCl, pH 7. In certain embodiments, the redox mediator has a formal potential negative of 0 mV versus Ag/AgCl in 0.1M NaCl, pH 7. In certain embodiments, the redox mediator has a formal potential negative of −100 mV versus Ag/AgCl in 0.1M NaCl, pH 7.

Embodiments of the analyte sensor disclosed herein include sensors in which the redox mediator is an Osmium complex.

In certain embodiments, the analyte detected and/or measured by the sensor described herein may be glucose and the enzyme may be glucose oxidase or glucose dehydrogenase. The glucose dehydrogenase may be pyrrole quinoline quinone glucose dehydrogenase (PQQ-GDH) or flavin-adenine dinucleotide glucose dehydrogenase (FAD-GDH).

In certain embodiments, the analyte detected and/or measured by the sensor described herein may be ketone and the enzyme included in the sensor is hydroxybutyrate dehydrogenase.

The analyte sensor may be an in vivo or in vitro analyte sensor. The in vitro analyte sensor may be a single use analyte sensor. The in vivo analyte sensor may be configured to provide continuous or automatic in vivo measurement of an individual's blood glucose concentration.

In certain embodiments, the first and second electrodes are in a facing configuration and are separated by a distance of about 100 μm. In other embodiments, the first and second electrodes are in a facing configuration and are separated by a distance of about 50 μm.

In certain cases, the analyte sensor comprises a first electrode consisting of carbon, gold or palladium, an enzyme specific for the analyte and a redox mediator disposed on the first electrode; a second electrode consisting essentially of platinum or platinized carbon, wherein the platinum is a catalyst for reducing atmospheric oxygen, and wherein the sensor does not include Ag/AgCl, wherein the catalyst mediates transfer of electrons generated from oxidation of the analyte to atmospheric oxygen.

In certain cases, the second electrode consists of platinized carbon. In other aspects, the second electrode consists of platinum.

Methods for manufacturing the sensors described herein are also provided. In certain embodiments, the method comprises providing a first substrate and a second substrate, the first substrate comprising a first major surface and a second major surface, the second substrate comprising a first major surface and a second major surface; disposing carbon, gold or palladium on the second major surface of the first substrate or the first major surface of the second substrate to form a first electrode; disposing platinum or platinized carbon on the second major surface of the first substrate or the first major surface of the second substrate to form a second electrode in absence of disposing a silver/silver chloride layer on the first or the second substrate; combining the first and second substrates to provide an analyte sensor.

In certain embodiments, the disposing comprises disposing platinized carbon at a density of at least about 4 μg/mm².

In certain cases, the disposing comprises disposing carbon, gold or palladium on the second major surface of the first substrate and disposing platinum or platinized carbon on the first major surface of the second substrate.

In other cases, the disposing comprises disposing carbon, gold or palladium and platinum or platinized carbon on the second major surface of the first substrate.

In certain embodiments, the method comprises disposing a reagent layer comprising glucose oxidase or glucose dehydrogenase and a redox mediator on the first electrode. In certain cases, the glucose dehydrogenase is pyrrole quinoline quinone glucose dehydrogenase or flavin-adenine dinucleotide glucose dehydrogenase.

In certain examples, the method comprises disposing a reagent layer comprising hydroxybutyrate dehydrogenase and a redox mediator on the first electrode.

In certain cases, combining the first and second substrates comprises including a spacer layer of 100 μm thickness between the second major surface of the first substrate and the first major surface of the second substrate.

In certain cases, combining the first and second substrates comprises including a spacer layer of 50 μm thickness between the second major surface of the first substrate and the first major surface of the second substrate.

Also provided herein is a method for analyzing an analyte in a sample of body fluid, the method comprising contacting the sample with an analyte sensor, the analyte sensor comprising a first electrode, comprising an enzyme specific for the analyte and a redox mediator a second electrode, comprising a catalyst for reducing oxygen, wherein the catalyst mediates transfer of electrons from the analyte to oxygen; and analyzing the analyte.

In certain aspects of the invention, the method does not require application of external potential to the analyte sensor in order to analyze the analyte in the sample of body fluid. The catalyst, analyte specific enzyme, and redox mediator included in the sensor used in the method are as provided herein.

### BRIEF DESCRIPTION OF THE DRAWINGS

A detailed description of various embodiments of the present disclosure is provided herein with reference to the accompanying drawings, which are briefly described below. The drawings are illustrative and are not necessarily drawn to scale. The drawings illustrate various embodiments of the present disclosure and may illustrate one or more embodiment(s) or example(s) of the present disclosure in whole or in part. A reference numeral, letter, and/or symbol that is used in one drawing to refer to a particular element may be used in another drawing to refer to a like element.

FIG. 1 shows a diagram of an embodiment of an analyte sensor according to the present disclosure.

FIG. 2 shows another embodiment of an analyte sensor according to the present disclosure.

FIG. 3 illustrates an embodiment of an analyte sensor according to the present disclosure.

FIG. 4 depicts the layers of the analyte sensor shown in FIG. 3.

FIG. 5 shows a schematic diagram of an embodiment of an analyte sensor according to an embodiment of the present disclosure.

FIG. 6 illustrates a typical curve obtained by using an analyte sensor as described herein to measure a glucose concentration.

FIG. 7 illustrates a log current plot obtained by using an analyte sensor as described herein.

FIG. 8 illustrates linearity of the test strip according to the present disclosure when tested over a range of glucose concentrations.

### DETAILED DESCRIPTION OF THE INVENTION

Before the embodiments of the present disclosure are described, it is to be understood that this invention is not limited to particular embodiments described, as such may, of course, vary. It is also to be understood that the terminology used herein is for the purpose of describing particular embodiments only, and is not intended to be limiting, since the scope of the embodiments of the invention will be embodied by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

All publications mentioned herein are incorporated herein by reference to disclose and describe the methods and/or materials in connection with which the publications are cited. The present disclosure is controlling to the extent there is a contradiction between the present disclosure and a publication incorporated by reference.

In the description of the invention herein, it will be understood that a word appearing in the singular encompasses its plural counterpart, and a word appearing in the plural encompasses its singular counterpart, unless implicitly or explicitly understood or stated otherwise. Merely by way of example, reference to “an” or “the” “analyte” encompasses a single analyte, as well as a combination and/or mixture of two or more different analytes, reference to “a” or “the” “concentration value” encompasses a single concentration value, as well as two or more concentration values, and the like, unless implicitly or explicitly understood or stated otherwise. Further, it will be understood that for any given component described herein, any of the possible candidates or alternatives listed for that component, may generally be used individually or in combination with one another, unless implicitly or explicitly understood or stated otherwise. Additionally, it will be understood that any list of such candidates or alternatives, is merely illustrative, not limiting, unless implicitly or explicitly understood or stated otherwise.

Various terms are described below to facilitate an understanding of the invention. It will be understood that a corresponding description of these various terms applies to corresponding linguistic or grammatical variations or forms of these various terms. It will also be understood that the invention is not limited to the terminology used herein, or the descriptions thereof, for the description of particular embodiments. Merely by way of example, the invention is not limited to particular analytes, bodily or tissue fluids, blood or capillary blood, or sensor constructs or usages, unless implicitly or explicitly understood or stated otherwise, as such may vary.

The publications discussed herein are provided solely for their disclosure prior to the filing date of the application. Nothing herein is to be construed as an admission that the embodiments of the invention are not entitled to antedate such publication by virtue of prior invention. Further, the dates of publication provided may be different from the actual publication dates which may need to be independently confirmed.

Analyte Sensors configured to use Oxygen as Oxidant

Generally, embodiments of the present disclosure relate to analyte sensors comprising a catalyst for reducing oxygen thereby facilitating the transfer of electrons generated by oxidation of an analyte to oxygen.

In general, an analyte sensor for analyzing an analyte is provided. The analyte sensor includes a first electrode, comprising an enzyme specific for the analyte and a redox mediator, a second electrode, comprising a catalyst for reducing oxygen, wherein the catalyst mediates transfer of electrons generated from oxidation of the analyte to oxygen. As such, oxygen is electroreduced at the second electrode.

In certain embodiments, the first electrode is a working electrode and the second electrode is a counter electrode or a dual purpose reference/counter electrode.

The analyte sensor and method of using and making the same as described herein are based on the discovery that including a catalyst in an analyte sensor, which catalyst promotes the reduction of oxygen provides a sensor that requires low amounts of mediator for transferring electrons from the analyte to the electrode at which the analyte is being oxidized, does not require an electron acceptor on the counter/reference electrode, and provides decreased variability between different sensor batches.

The reduction in the amounts of mediator also has the added advantage of lowering any background signal generated in absence of an analyte.

The lack of requirement of an electron acceptor at the counter/reference electrode simplifies the production of the analyte sensor since a layer of the electron acceptor no longer needs to be deposited on the reference electrode. In certain embodiments, the analyte sensor as disclosed herein does not include a counter/reference electrode or a reference electrode comprising silver/silver chloride (Ag/AgCl). This analyte sensor lacking a counter/reference electrode comprising Ag/AgCl leads to simplified manufacturing process with substantially reduced variation between different sensors which variation may have been introduced during the process of including Ag/AgCl in the reference/counter electrode. In certain cases, the analyte sensor described herein has reduced sensor to sensor variability as the process of manufacturing the sensor does not involve depositing a layer of a mixture of Ag and AgCl on the counter/reference electrode.

In certain embodiments, the analyte sensor comprising a catalyst for reducing oxygen provides a higher signal than the signal obtained from analysis of the analyte by a similar sensor but lacking the catalyst and in certain cases including an electron acceptor (e.g., Ag/AgCl) on the counter/reference electrode.

In certain cases, the analyte sensor comprising a catalyst for reducing oxygen at the counter/reference electrode provides a signal from electrolysis of an analyte in a sample that is at least 5%, or 10%, or 15%, or 20%, or 30%, or 40%, or 50%, or 60%, or 70%, or 80%, or 90%, or 100%, or 120%, or 130% higher than the signal generated from electrolysis of the analyte in the sample using a similar analyte sensor but not comprising a catalyst for reducing oxygen at the counter/reference electrode. In certain embodiments, the higher signal is generated within 0.01 second, or 0.03 second, or 0.01 second, or 0.3 second, or 0.6 second, or 1 second, or 1.3 seconds, or 1.6 seconds, or 2 seconds, or 3 seconds, or 4 seconds, or 5 seconds, or more of applying the sample to the analyte sensor.

As used herein, “signal” refers to current, charge, resistance, voltage, impedance, or log or integrated values thereof that is related to the concentration of the analyte being analyzed by the sensor.

Generally, electrochemical sensors include an electron acceptor for accepting the electrons generated from enzyme mediated oxidation of an analyte. In some electrochemical sensors a high amount of redox mediator serves the role of electron acceptor. In this case, the mediator is present in a large molar access compared to the analyte. A small fraction of the mediator is used to mediate transfer of electrons from the analyte and the analyte derived electrons ultimately reside on the reduced mediator molecules. A disadvantage of these sensors is that some of the mediator is present in reduced form before the analyte is added to the sensor leading to a non-analyte related background signal.

Electrochemical sensors designed to reduce the background signal by reducing the amount of mediator include an electron acceptor (an oxidant) on the counter electrode (which may be a dual function counter-reference electrode). The electron acceptor may be AgCl coated onto the counter electrode as a mixture of Ag and AgCl. The electrons generated by oxidation of an analyte are transferred by the mediator to the working electrode and via the meter to AgCl generating Ag. However, the inclusion of an electron acceptor (an oxidant) on the counter electrode, such as, depositing a mixture of Ag and AgCl on the counter/reference electrode is a challenging step which may introduce significant variability in the amount of and/or position of the electron acceptor present in the analyte sensors leading to analyte sensors that vary in the response or signal generated from oxidation of the same amount of analyte.

The sensor and the methods disclosed herein have the dual benefit of utilizing low amounts of mediators as well as needing a relatively simple manufacturing process that reduces strip to strip variability.

As noted above, the analyte sensor includes a catalyst for facilitating transfer of electrons generated by oxidation of an analyte (e.g., glucose or ketone) at the working electrode to oxygen at the counter/reference electrode. In certain embodiments, the analyte sensor may include a working electrode comprising a sensing layer and a counter/reference electrode comprising the catalyst. The sensing layer may include an analyte specific enzyme and a redox mediator. The electrodes may both be disposed on a single substrate or disposed on separate substrates. The counter/reference electrode may comprise the catalyst. In certain embodiments, the catalyst may be disposed on the portion of the counter/reference electrode that comes in contact with a sample. In certain embodiments, the catalyst may be disposed on substantially the whole portion of the counter/reference electrode that comes in contact with a sample or may be disposed on a certain area of the counter/reference electrode. In certain cases, the working electrode does not include a catalyst included in the reference or counter or the reference/counter electrode. For example, the working electrode does not comprise platinum or other catalytic forms of platinum.

In some embodiments, the catalyst may be platinum. In certain embodiments, the catalyst comprises platinized carbon. In other embodiments, the platinum catalyst may be provided as platinum nanoparticles. In certain aspects, the platinum catalyst may be provided as high-index facets of platinum nanoparticles. In other aspect, the catalyst may be an alloy of platinum with another metal such as Nickel, for example, the catalyst may be Pt₃Ni(111).

In certain embodiments, the first electrode is a working electrode. In certain cases, the working electrode is composed from a material consisting of gold, carbon, or palladium. The working electrode includes an enzyme specific for the analyte, and a redox mediator. The second electrode may be a counter electrode or a dual purpose reference/counter electrode. In certain cases, the counter or counter/reference electrode consists essentially of platinum, wherein the platinum is a catalyst for reducing atmospheric oxygen, and wherein the counter or counter/reference electrode does not include Ag/AgCl, wherein the catalyst mediates transfer of electrons generated from oxidation of the analyte to atmospheric oxygen.

In certain aspects, the counter or counter/reference electrode consists of platinized carbon. In other aspects, the counter or counter/reference electrode consists of platinum.

The amount of catalyst that may be present in the counter/reference electrode may be in the range of about 1 nanogram (ng) to about 1 milligram (mg). For example, the amount of catalyst present per square millimeter of an electrode may be in the range of about 10 ng-about 100 μg, such as, 100 ng-100 μg, more specifically, about 1 μg-100 μg, or 2 μg-90 μg, 3 μg-80 μg, 4 μg-70 μg, 5 μg-60 μg, 6 μg-50 μg, 8 μg-40 μg, 10 μg-30 μg, 20 μg-25 μg, for example, about 1 μg/mm², 3 μg/mm², 5 μg/mm², 10 μg/mm², 30 μg/mm², 100 μg/mm². In certain embodiments, the sensor includes a second electrode made of platinized carbon, wherein the density of platinized carbon is at least 4 μg/mm². For example, the density of platinized carbon may be in the range of 4 μg/mm²-100 μg/mm², e.g., 4 μg/mm²-75 μg/mm², or 4 μg/mm²-50 μg/mm², or 4 μg/mm²-30 μg/mm².

As noted above, the analyte sensor as described herein include a counter electrode or a counter/reference electrode that includes a catalyst for reducing oxygen. The counter or a counter/reference electrode does not include an electron acceptor such as AgCl.

In addition, the analyte sensor provided herein includes a mediator having a redox potential ranging from about −200 mV to about +200 mV versus the standard calomel electrode (SCE). For example, the redox mediator has a formal potential of −200 mV vs. SCE, or −100 mV vs. SCE, or 0 V vs. SCE, or +100 mV vs. SCE, or +200 mV vs. SCE.

In certain embodiments, a redox mediator included in the sensors as disclosed herein has a formal redox potential in the range of about −200 mV to about +200 mV versus Ag/AgCl in physiological condition (0.1M NaC1, pH 7). For example, the redox mediator has a formal potential negative of +200 mV versus Ag/AgCl in 0.1M NaCl, pH 7. In certain cases, the redox mediator has a formal potential negative of +100 mV versus Ag/AgCl in 0.1M NaCl, pH 7. In certain embodiments, the redox mediator has a formal potential negative of 0 mV versus Ag/AgCl in 0.1M NaCl, pH 7. In certain embodiments, the redox mediator has a formal potential negative of −100 mV versus Ag/AgCl in 0.1M NaCl, pH 7.

In certain embodiments, the mediator may be present in the analyte sensor at a concentration ranging from about 0.3 mM to about 100 mM. For example, the mediator may be present on a first electrode of the analyte sensor at a concentration in the range of 0.3-0.5 mM, about 0.3-1 mM, about 0.3-3 mM, about 0.3-10 mM, about 0.3-15 mM, about 0.3-20 mM, about 0.3-25 mM.

Embodiments of the analyte sensor disclosed herein include sensors in which the redox mediator is an Osmium complex. Redox mediator that are of interest include osmium transition metal complexes with one or more ligands, each ligand having a nitrogen-containing heterocycle such as 2,2′-bipyridine, 1,10-phenanthroline, 1-methyl, 2-pyridyl biimidazole, or derivatives thereof. The redox mediators (electron transfer agents) may also have one or more ligands covalently bound in a polymer, each ligand having at least one nitrogen-containing heterocycle, such as pyridine, imidazole, or derivatives thereof. One example of an electron transfer agent includes (a) a polymer or copolymer having pyridine or imidazole functional groups and (b) osmium cations complexed with two ligands, each ligand containing 2,2′-bipyridine, 1,10-phenanthroline, or derivatives thereof, the two ligands not necessarily being the same. Some derivatives of 2,2′-bipyridine for complexation with the osmium cation include but are not limited to 4,4′-dimethyl-2,2′-bipyridine and mono-, di-, and polyalkoxy-2,2′-bipyridines, including 4,4′-dimethoxy-2,2′-bipyridine. Derivatives of 1,10-phenanthroline for complexation with the osmium cation include but are not limited to 4,7-dimethyl-1,10-phenanthroline and mono, di-, and polyalkoxy-1,10-phenanthrolines, such as 4,7-dimethoxy-1,10-phenanthroline. Polymers for complexation with the osmium cation include but are not limited to polymers and copolymers of poly(1-vinyl imidazole) (referred to as “PVI”) and poly(4-vinyl pyridine) (referred to as “PVP”). Suitable copolymer substituents of poly(1-vinyl imidazole) include acrylonitrile, acrylamide, and substituted or quaternized N-vinyl imidazole, e.g., electron transfer agents with osmium complexed to a polymer or copolymer of poly(1-vinyl imidazole).

In certain embodiments, the analyte detected and/or measured by the sensor described herein is glucose and the enzyme included in the sensor is glucose oxidase or glucose dehydrogenase. In certain cases, the glucose dehydrogenase is pyrrole quinoline quinone glucose dehydrogenase. In other cases, the glucose dehydrogenase is flavin-adenine dinucleotide glucose dehydrogenase.

In certain embodiments, the analyte detected and/or measured by the sensor described herein may be ketone and the enzyme included in the sensor is hydroxybutyrate dehydrogenase.

In certain embodiments, the first and second electrodes are in a facing configuration and are separated by a distance of about 100 μm. In other embodiments, the first and second electrodes are in a facing configuration and are separated by a distance of about 50 μm.

In certain embodiments of the present disclosure, inclusion of the catalyst for reducing oxygen results in an increase in the accuracy of the analyte measurements from the sensor. For example, inclusion of the catalyst for reducing oxygen may result in better correlation between the analyte concentration as determined by an in vitro analyte monitoring device (e.g., based on signals detected from the in vitro analyte sensor by a device operably connected to the sensor, for example, a meter) and a reference analyte concentration. In certain instances, inclusion of the catalyst for reducing oxygen results in analyte concentrations as determined by the signals detected from the analyte sensor that are within 50% of a reference value, such as within 40% of the reference value, including within 30% of the reference value, or within 20% of the reference value, or within 10% of the reference value, or within 5% of the reference value, or within 2% of the reference value, or within 1% of the reference value. In some cases, 75% of the analyte sensors as described herein demonstrate the accuracy (e.g., is within a percentage of a reference value, as described above). In some cases, 80% or more, or 90% or more, including 95% or more, or 97% or more, or 99% or more of the analyte sensors as described herein demonstrate the accuracy (e.g., is within a percentage of a reference value, as described above). As an alternative measure of accuracy, in some cases, inclusion of the catalyst for reducing oxygen results in analyte concentrations as determined by the signals detected from the analyte sensor that are within Zone A of the Clarke Error Grid Analysis. For example, inclusion of the catalyst for reducing oxygen may result in analyte concentrations as determined by the signals detected from the analyte sensor that are within Zone A of the Clarke Error Grid Analysis for 75% or more of the analyte sensors, such as 80% or more, or 90% or more, including 95% or more, or 97% or more, or 99% or more of the analyte sensors. In certain instances, inclusion of the catalyst for reducing oxygen results in analyte concentrations as determined by the signals detected from the analyte sensor that are within Zone A or Zone B of the Clarke Error Grid Analysis. For example, inclusion of the catalyst for reducing oxygen may result in analyte concentrations as determined by the signals detected from the analyte sensor that are within Zone A or Zone B of the Clarke Error Grid Analysis for 75% or more of the analyte sensors, such as 80% or more, or 90% or more, including 95% or more, or 97% or more, or 99% or more of the analyte sensors. Further information regarding the Clarke Error Grid Analysis is found in Clarke, W. L. et al. “Evaluating Clinical Accuracy of Systems for Self-Monitoring of Blood Glucose” Diabetes Care, vol. 10, no. 5, 1987: 622-628.

In certain embodiments, sensors that include a catalyst for reducing oxygen have a sensitivity of 0.1 nA/mM or more of analyte detected and/or measured by the sensor, or 0.5 nA/mM or more, such as 1 nA/mM or more, including 1.5 nA/mM or more, for instance 2 nA/mM or more, or 2.5 nA/mM or more, or 3 nA/mM or more, or 3.5 nA/mM or more, or 4 nA/mM or more, or 4.5 nA/mM or more, or 5 nA/mM or more of analyte detected and/or measured by the sensor. In some cases, sensors that include a catalyst on the counter electrode for reducing oxygen have a sensitivity ranging from 0.1 nA/mM to 5 nA/mM of analyte detected and/or measured by the sensor, such as from 0.1 nA/mM to 4.5 nA/mM, including from 0.1 nA/mM to 4 nA/mM, or from 0.2 nA/mM to 3.5 nA/mM, or from 0.2 nA/mM to 3 nA/mM, or from 0.3 nA/mM to 2.5 nA/mM, or from 0.3 nA/mM to 2 nA/mM of analyte detected and/or measured by the sensor.

### Electrochemical Sensors

Embodiments of the present disclosure relate to methods and devices for detecting at least one analyte, including glucose, in body fluid. Embodiments relate to the continuous and/or automatic in vivo monitoring of the level of one or more analytes using a continuous analyte monitoring system that includes an analyte sensor at least a portion of which is to be positioned beneath a skin surface of a user for a period of time and/or the discrete monitoring of one or more analytes using an in vitro blood glucose (“BG”) meter and an analyte test strip. Embodiments include combined or combinable devices, systems and methods and/or transferring data between an in vivo continuous system and an in vitro system. In some embodiments, the systems, or at least a portion of the systems, are integrated into a single unit.

A sensor as described herein may be an in vivo sensor or an in vitro sensor (e.g., a discrete monitoring test strip). Embodiments of the present disclosure include analyte monitoring devices and systems that include an analyte sensor, at least a portion of which is positionable beneath the skin surface of the user for the in vivo detection of an analyte, including glucose, lactate, and the like, in a body fluid. Embodiments include wholly implantable analyte sensors and analyte sensors in which only a portion of the sensor is positioned under the skin and a portion of the sensor resides above the skin, e.g., for contact to a sensor control unit (which may include a transmitter), a receiver/display unit, transceiver, processor, etc. The sensor may be, for example, subcutaneously positionable in a user for the continuous or periodic monitoring of a level of an analyte in the user's interstitial fluid. For the purposes of this description, continuous monitoring and periodic monitoring will be used interchangeably, unless noted otherwise and are intended to include both continuous and on-demand analyte measurement systems known in the art. The sensor response may be correlated and/or converted to analyte levels in blood or other fluids. In certain embodiments, an analyte sensor may be positioned in contact with interstitial fluid to detect the level of glucose, which detected glucose may be used to infer the glucose level in the user's bloodstream. Analyte sensors may be insertable into a vein, artery, or other portion of the body containing fluid. Embodiments of the analyte sensors may be configured for monitoring the level of the analyte over a time period which may range from seconds, minutes, hours, days, weeks, to months, or longer.

In certain embodiments, the analyte sensors, such as glucose sensors, are capable of in vivo detection of an analyte for one hour or more, e.g., a few hours or more, e.g., a few days or more, e.g., three or more days, e.g., five days or more, e.g., seven days or more, e.g., several weeks or more, or one month or more. Future analyte levels may be predicted based on information obtained, e.g., the current analyte level at time t₀, the rate of change of the analyte, etc. Predictive alarms may notify the user of a predicted analyte level that may be of concern in advance of the user's analyte level reaching the future predicted analyte level. This provides the user an opportunity to take corrective action.

Analytes that may be monitored include, but are not limited to, acetyl choline, amylase, bilirubin, cholesterol, chorionic gonadotropin, glycosylated hemoglobin (HbAlc), creatine kinase (e.g., CK-MB), creatine, creatinine, DNA, fructosamine, glucose, glucose derivatives, glutamine, growth hormones, hormones, ketones, ketone bodies, lactate, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be monitored. In embodiments that monitor more than one analyte, the analytes may be monitored at the same or different times.

Analyte sensors may include an analyte-responsive enzyme to provide a sensing element. In many embodiments, the sensing element is formed near or on only a small portion of at least a working electrode. Each sensing element includes one or more components constructed to facilitate the electrochemical oxidation or reduction of the analyte. The sensing element may include, for example, an analyte-specific enzyme that reacts with the analyte to produce a response at the working electrode, an electron transfer agent to transfer electrons between the analyte and the working electrode (or other component), or both.

A variety of different sensing element configurations may be used. In certain embodiments, the sensing elements are deposited on the conductive material of a working electrode. The sensing elements may extend beyond the conductive material of the working electrode. In some cases, the sensing elements may also extend over other electrodes, e.g., over the counter electrode and/or reference electrode (or counter/reference where provided). In other embodiments, the sensing elements are contained on the working electrode, such that the sensing elements do not extend beyond the conductive material of the working electrode. In some embodiments a working electrode is configured to include a plurality of spatially distinct sensing elements. Additional information related to the use of spatially distinct sensing elements can be found in U.S. Provisional Application No. 61/421,371, entitled “Analyte Sensors with Reduced Sensitivity Variation,” which was filed on Dec. 9, 2010, and which is incorporated by reference herein in its entirety and for all purposes.

The terms “working electrode”, “counter electrode”, “reference electrode” and “counter/reference electrode” are used herein to refer to a portion or portions of a conductive trace which are configured to function as a working electrode, counter electrode, reference electrode or a counter/reference electrode respectively. In other words, a working electrode is that portion of a conductive trace which functions as a working electrode as described herein, e.g., that portion of a conductive trace which is exposed to an environment containing the analyte or analytes to be measured and not covered by an insulative layer, and which, in some cases, has been modified with one or more sensing elements as described herein. Similarly, a reference electrode is that portion of a conductive trace which function as a reference electrode as described herein, e.g., that portion of a conductive trace which is exposed to an environment containing the analyte or analytes to be measured and not covered by an insulative layer. A counter electrode is that portion of a conductive trace which is configured to function as a counter electrode as described herein, e.g., that portion of a conductive trace which is exposed to an environment containing the analyte or analytes to be measured and not covered by an insulative layer, and which, in some cases, includes a secondary conductive layer, e.g., a catalyst layer comprising a catalyst for reducing oxygen by transferring electrons (generated by oxidation of analyte, transferred to meter from the working electrode) to oxygen at the counter electrode. As noted above, in some embodiments, a portion of a conductive trace may function as both of a counter electrode and a reference electrode.

Sensing elements that are in direct contact with the working electrode trace may contain an electron transfer agent to transfer electrons directly or indirectly between the analyte and the working electrode, and/or an enzyme to facilitate a reaction of the analyte. For example, glucose oxidase or glucose dehydrogenase to facilitate a reaction of glucose.

In other embodiments the sensing elements are not deposited directly on the working electrode trace. Instead, the sensing elements may be spaced apart from the working electrode trace, and separated from the working electrode trace, e.g., by a separation layer. A separation layer may include one or more membranes or films or a physical distance. In addition to separating the working electrode trace from the sensing elements, the separation layer may also act as a mass transport limiting layer and/or an interferent eliminating layer and/or a biocompatible layer.

In certain embodiments which include more than one working electrode, one or more of the working electrodes may not have corresponding sensing elements, or may have sensing elements that do not contain one or more components (e.g., an electron transfer agent and/or catalyst) needed to electrolyze the analyte. Thus, the signal at this working electrode may correspond to background signal which may be removed from the analyte signal obtained from one or more other working electrodes that are associated with fully-functional sensing elements by, for example, subtracting the signal.

In certain embodiments, the sensing elements include one or more electron transfer agents. Electron transfer agents that may be employed are electroreducible and electrooxidizable ions or molecules having redox potentials that are a few hundred millivolts above or below the redox potential of the standard calomel electrode (SCE). The electron transfer agent may be organic, organometallic, or inorganic. Examples of organic redox species are quinones and species that in their oxidized state have quinoid structures, such as Nile blue and indophenol. Examples of organometallic redox species are metallocenes including ferrocene. Examples of inorganic redox species are hexacyanoferrate (III), ruthenium hexamine, etc. Additional examples include those described in U.S. Pat. Nos. 6,736,957, 7,501,053 and 7,754,093, the disclosures of each of which are incorporated herein by reference in their entirety.

In certain embodiments, electron transfer agents have structures or charges which prevent or substantially reduce the diffusional loss of the electron transfer agent during the period of time that the sample is being analyzed. For example, electron transfer agents include but are not limited to a redox species, e.g., bound to a polymer which can in turn be disposed on or near the working electrode. The bond between the redox species and the polymer may be covalent, coordinative, or ionic. Although any organic, organometallic or inorganic redox species may be bound to a polymer and used as an electron transfer agent, in certain embodiments the redox species is a transition metal compound or complex, e.g., osmium, ruthenium, iron, and cobalt compounds or complexes. It will be recognized that many redox species described for use with a polymeric component may also be used, without a polymeric component.

Embodiments of polymeric electron transfer agents may contain a redox species covalently bound in a polymeric composition. An example of this type of mediator is poly(vinylferrocene). Another type of electron transfer agent contains an ionically-bound redox species. This type of mediator may include a charged polymer coupled to an oppositely charged redox species. Examples of this type of mediator include a negatively charged polymer coupled to a positively charged redox species such as an osmium or ruthenium polypyridyl cation. Another example of an ionically-bound mediator is a positively charged polymer including quaternized poly(4-vinyl pyridine) or poly(1-vinyl imidazole) coupled to a negatively charged redox species such as ferricyanide or ferrocyanide. In other embodiments, electron transfer agents include a redox species coordinatively bound to a polymer. For example, the mediator may be formed by coordination of an osmium or cobalt 2,2′-bipyridyl complex to poly(1-vinyl imidazole) or poly(4-vinyl pyridine).

Suitable electron transfer agents are osmium transition metal complexes with one or more ligands, each ligand having a nitrogen-containing heterocycle such as 2,2′-bipyridine, 1,10-phenanthroline, 1-methyl, 2-pyridyl biimidazole, or derivatives thereof. The electron transfer agents may also have one or more ligands covalently bound in a polymer, each ligand having at least one nitrogen-containing heterocycle, such as pyridine, imidazole, or derivatives thereof. One example of an electron transfer agent includes (a) a polymer or copolymer having pyridine or imidazole functional groups and (b) osmium cations complexed with two ligands, each ligand containing 2,2′-bipyridine, 1,10-phenanthroline, or derivatives thereof, the two ligands not necessarily being the same. Some derivatives of 2,2′-bipyridine for complexation with the osmium cation include but are not limited to 4,4′-dimethyl-2,2′-bipyridine and mono-, di-, and polyalkoxy-2,2′-bipyridines, including 4,4′-dimethoxy-2,2′-bipyridine. Derivatives of 1,10-phenanthroline for complexation with the osmium cation include but are not limited to 4,7-dimethyl-1,10-phenanthroline and mono, di-, and polyalkoxy-1,10-phenanthrolines, such as 4,7-dimethoxy-1,10-phenanthroline. Polymers for complexation with the osmium cation include but are not limited to polymers and copolymers of poly(1-vinyl imidazole) (referred to as “PVI”) and poly(4-vinyl pyridine) (referred to as “PVP”). Suitable copolymer substituents of poly(1-vinyl imidazole) include acrylonitrile, acrylamide, and substituted or quaternized N-vinyl imidazole, e.g., electron transfer agents with osmium complexed to a polymer or copolymer of poly(l-vinyl imidazole).

Embodiments may employ electron transfer agents having a redox potential ranging from about −200 mV to about +200 mV versus the standard calomel electrode (SCE). The sensing elements may also include a catalyst which is capable of catalyzing a reaction of the analyte. The catalyst may also, in some embodiments, act as an electron transfer agent. One example of a suitable catalyst is an enzyme which catalyzes a reaction of the analyte. For example, a catalyst, including a glucose oxidase, glucose dehydrogenase (e.g., pyrroloquinoline quinone (PQQ), dependent glucose dehydrogenase, flavine adenine dinucleotide (FAD) dependent glucose dehydrogenase, or nicotinamide adenine dinucleotide (NAD) dependent glucose dehydrogenase), may be used when the analyte of interest is glucose. A lactate oxidase or lactate dehydrogenase may be used when the analyte of interest is lactate.

In certain embodiments, an analyte specific enzyme may be attached to a polymer, cross linking the catalyst with another electron transfer agent, which, as described above, may be polymeric.

In certain embodiments, the sensor works at a low oxidizing potential, e.g., a potential of about +40 mV vs. Ag/AgCl. This sensing elements use, for example, an osmium (Os)-based mediator constructed for low potential operation. Accordingly, in certain embodiments the sensing elements are redox active components that include: (1) osmium-based mediator molecules that include (bidente) ligands, and (2) glucose oxidase enzyme molecules. These two constituents are combined together in the sensing elements of the sensor.

A mass transport limiting layer (not shown), e.g., an analyte flux modulating layer, may be included with the sensor to act as a diffusion-limiting barrier to reduce the rate of mass transport of the analyte, for example, glucose or lactate, into the region around the working electrodes. The mass transport limiting layers are useful in limiting the flux of an analyte to a working electrode in an electrochemical sensor so that the sensor is linearly responsive over a large range of analyte concentrations and is easily calibrated. Mass transport limiting layers may include polymers and may be biocompatible. A mass transport limiting layer may provide many functions, e.g., biocompatibility and/or interferent-eliminating functions, etc.

A mass transport limiting layer may be applied to an analyte sensor as described herein via any of a variety of suitable methods, including, e.g., dip coating and slot die coating.

In certain embodiments, a mass transport limiting layer is a membrane composed of crosslinked polymers containing heterocyclic nitrogen groups, such as polymers of polyvinylpyridine and polyvinylimidazole. Embodiments also include membranes that are made of a polyurethane, or polyether urethane, or chemically related material, or membranes that are made of silicone, and the like.

A membrane may be formed by crosslinking in situ a polymer, modified with a zwitterionic moiety, a non-pyridine copolymer component, and optionally another moiety that is either hydrophilic or hydrophobic, and/or has other desirable properties, in an alcohol-buffer solution. The modified polymer may be made from a precursor polymer containing heterocyclic nitrogen groups. For example, a precursor polymer may be polyvinylpyridine or polyvinylimidazole. Optionally, hydrophilic or hydrophobic modifiers may be used to “fine-tune” the permeability of the resulting membrane to an analyte of interest. Optional hydrophilic modifiers, such as poly(ethylene glycol), hydroxyl or polyhydroxyl modifiers, may be used to enhance the biocompatibility of the polymer or the resulting membrane.

A membrane may be formed in situ by applying an alcohol-buffer solution of a crosslinker and a modified polymer over the enzyme-containing sensing elements and allowing the solution to cure for about one to two days or other appropriate time period. The crosslinker-polymer solution may be applied over the sensing elements by placing a droplet or droplets of the membrane solution on the sensor, by dipping the sensor into the membrane solution, by spraying the membrane solution on the sensor, and the like. Generally, the thickness of the membrane is controlled by the concentration of the membrane solution, by the number of droplets of the membrane solution applied, by the number of times the sensor is dipped in the membrane solution, by the volume of membrane solution sprayed on the sensor, or by any combination of these factors. A membrane applied in this manner may have any combination of the following functions: (1) mass transport limitation, i.e., reduction of the flux of analyte that can reach the sensing elements, (2) biocompatibility enhancement, or (3) interferent reduction.

In some embodiments, a membrane composition for use as a mass transport limiting layer may include one or more leveling agents, e.g., polydimethylsiloxane (PDMS). Additional information with respect to the use of leveling agents can be found, for example, in US Patent Application Publication No. US 2010/0081905, the disclosure of which is incorporated by reference herein in its entirety.

In some instances, the membrane may form one or more bonds with the sensing elements. By bonds is meant any type of an interaction between atoms or molecules that allows chemical compounds to form associations with each other, such as, but not limited to, covalent bonds, ionic bonds, dipole-dipole interactions, hydrogen bonds, London dispersion forces, and the like. For example, in situ polymerization of the membrane can form crosslinks between the polymers of the membrane and the polymers in the sensing elements. In certain embodiments, crosslinking of the membrane to the sensing element facilitates a reduction in the occurrence of delamination of the membrane from the sensor.

In another example, a potentiometric sensor can be constructed as follows. Glucose-sensing elements may be constructed by combining together (1) a redox mediator having a transition metal complex including Os polypyridyl complexes with oxidation potentials from about −200 mV to +200 mV vs. SCE, and (2) glucose oxidase. This sensor can then be used in a potentiometric mode, by exposing the sensor to a glucose containing solution, under conditions of zero current flow, and allowing the ratio of reduced/oxidized Os to reach an equilibrium value. The reduced/oxidized Os ratio varies in a reproducible way with the glucose concentration, and will cause the electrode's potential to vary in a similar way.

The substrate may be formed using a variety of non-conducting materials, including, for example, polymeric or plastic materials and ceramic materials. Suitable materials for a particular sensor may be determined, at least in part, based on the desired use of the sensor and properties of the materials.

In some embodiments, the substrate is flexible. For example, if the sensor is configured for implantation into a user, then the sensor may be made flexible (although rigid sensors may also be used for implantable sensors) to reduce pain to the user and damage to the tissue caused by the implantation of and/or the wearing of the sensor. A flexible substrate often increases the user's comfort and allows a wider range of activities. Suitable materials for a flexible substrate include, for example, non-conducting plastic or polymeric materials and other non-conducting, flexible, deformable materials. Examples of useful plastic or polymeric materials include thermoplastics such as polycarbonates, polyesters (e.g., Mylar™ and polyethylene terephthalate (PET)), polyvinyl chloride (PVC), polyurethanes, polyethers, polyamides, polyimides, or copolymers of these thermoplastics, such as PETG (glycol-modified polyethylene terephthalate).

In other embodiments, the sensors are made using a relatively rigid substrate to, for example, provide structural support against bending or breaking. Examples of rigid materials that may be used as the substrate include poorly conducting ceramics, such as aluminum oxide and silicon dioxide. An implantable sensor having a rigid substrate may have a sharp point and/or a sharp edge to aid in implantation of a sensor without an additional insertion device.

It will be appreciated that for many sensors and sensor applications, both rigid and flexible sensors will operate adequately. The flexibility of the sensor may also be controlled and varied along a continuum by changing, for example, the composition and/or thickness of the substrate.

In addition to considerations regarding flexibility, it is often desirable that implantable sensors should have a substrate which is physiologically harmless, for example, a substrate approved by a regulatory agency or private institution for in vivo use.

The sensor may include optional features to facilitate insertion of an implantable sensor. For example, the sensor may be pointed at the tip to ease insertion. In addition, the sensor may include a barb which assists in anchoring the sensor within the tissue of the user during operation of the sensor. However, the barb is typically small enough so that little damage is caused to the subcutaneous tissue when the sensor is removed for replacement.

An implantable sensor may also, optionally, have an anticlotting agent disposed on a portion of the substrate which is implanted into a user. This anticlotting agent may reduce or eliminate the clotting of blood or other body fluid around the sensor, particularly after insertion of the sensor. Blood clots may foul the sensor or irreproducibly reduce the amount of analyte which diffuses into the sensor. Examples of useful anticlotting agents include heparin and tissue plasminogen activator (TPA), as well as other known anticlotting agents.

The anticlotting agent may be applied to at least a portion of that part of the sensor that is to be implanted. The anticlotting agent may be applied, for example, by bath, spraying, brushing, or dipping, etc. The anticlotting agent is allowed to dry on the sensor. The anticlotting agent may be immobilized on the surface of the sensor or it may be allowed to diffuse away from the sensor surface. The quantities of anticlotting agent disposed on the sensor may be below the amounts typically used for treatment of medical conditions involving blood clots and, therefore, have only a limited, localized effect.

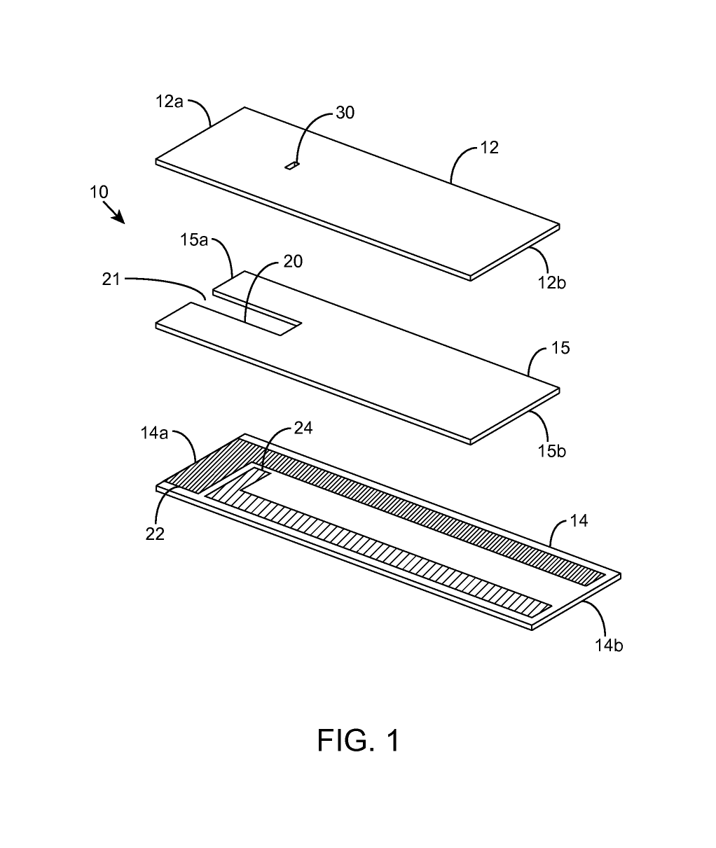

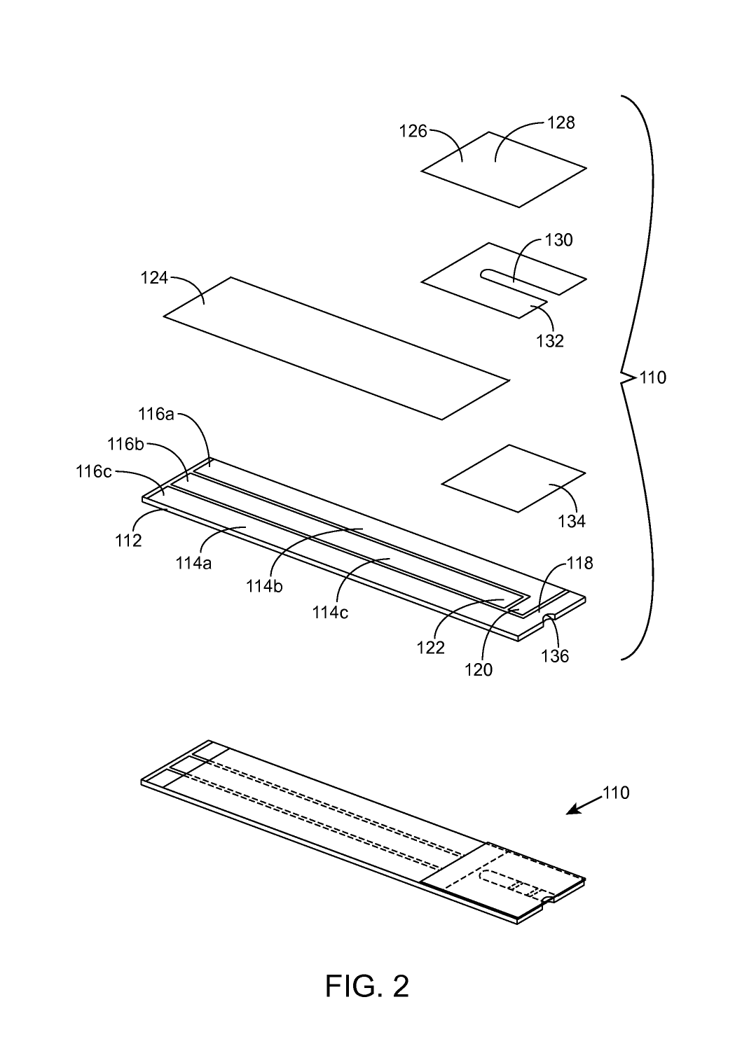

Exemplary in vitro analyte sensors include analyte sensors with coplanar electrodes are illustrated in FIGS. 1 and 2.

Referring to FIG. 1, an embodiment of an analyte sensor is illustrated as analyte sensor 10. The analyte sensor strip 10 has a first substrate 12, a second substrate 14, and a spacer 15 positioned therebetween. Analyte sensor strip 10 includes at least one working electrode 22 and at least one counter electrode 24.

Analyte sensor strip 10 has a first, proximal end and an opposite, distal end. At proximal end, sample to be analyzed is applied to sensor 10. Proximal end could be referred as “the fill end” or “sample receiving end”. Distal end of sensor 10 is configured for operable connection to a device such as a meter. Sensor strip 10 is a layered construction, in certain embodiments having a generally rectangular shape, which is formed by first and second substrates 12, 14. Substrate 12 includes first or proximal end 12A and second or distal end 12B, and substrate 14 includes first or proximal end 14A and second or distal end 14B.

Sensor strip 10 includes sample chamber 20 having an inlet 21 for access to sample chamber 20. Sensor strip 10 is a tip-fill sensor, having inlet 21 at proximal end.

Sample chamber 20 is defined by substrate 12, substrate 14 and spacer 15. Generally opposite to inlet 21, through substrate 12 is a vent 30 from sample chamber 20.

For sensor 10, at least one working electrode 22 is illustrated on substrate 14. Working electrode 22 extends from end 14A into sample chamber 20 to end 14B. Sensor 10 also includes at least one counter electrode 24, in this embodiment on substrate 14. Counter electrode 24 extends from sample chamber 20, proximate first proximal end to distal end. Working electrode 22 and counter electrode 24 are present on the same substrate e.g., as planar or co-planar electrodes. The electrodes 22, 24 may include sensing chemistry material(s) thereon. Optionally, a mesh layer may also be present in the sample chamber.

Referring now to FIG. 2, an analyte sensor 110 is shown. Analyte sensor 110 comprises a substrate 112 on which counter electrode 118, a working electrode 120, and a reference electrode 122 with conductive tracks 114a, 114b, and 114c and tabs 116a, 116b, and 116c for connection to a measurement device are present.

The conductive tracks 114a, 114b, and 114c can optionally be overlaid with an opaque tape layer 124 which comprises an adhesive coating on the lower surface. The adhesive may be a pressure-sensitive adhesive.

In the analyte sensor 110 in FIG. 2, sample chamber 130 is formed by disposing a spacer layer 132 having a cut-out over the working, counter, and reference electrodes. Optionally, a cover layer 126 defining the upper boundary of the sample chamber 30 can overlay the spacer layer 132. The lower surface of the cover layer may be coated with a hydrophilic coating, which may contain surfactants to promote filling of the biological sample into the sample chamber. The cover layer 126 may be transparent such that the progress of sample filling into the sample chamber can be monitored visually. The cover layer 126 may include a vent 128 to allow release of air displaced from the sample chamber 130 by the ingress of biological sample.

A sensing layer 134 may be disposed in the sample chamber. The sensing layer 134 may include an analyte specific enzyme and a redox mediator. The sensing layer 134 may be disposed as a thin (˜5 μm) film. In one embodiment, the sensing layer 134 may span the working, counter, and reference electrodes.

The spacer layer 132 may be a thin (˜100 μm) polymer tape layer with pressure-sensitive adhesive (PSA) on both surfaces. The spacer layer defines the dimensions (height and surface area) and shape of the sample chamber 130 and the area of the sensing layer 134 that is exposed to the biological sample. Optionally, a mesh layer may also be present in the sample chamber.

A biological sample application/receiving area 136 may in one embodiment be a notch cut in the end of the electrode strip to identify to the user the point at which the biological sample should be applied. This receiving area 136 may also define the entrance to the sample chamber and promote ingress of the sample into the chamber.

In certain embodiments, the sample application/receiving area may be a protrusion that extends from the substrate 112 that may define the entrance to the sample chamber and promote ingress of the sample into the chamber. The protrusion may be formed by the substrate 112 and cover 126 to provide a tab which may be used to contact a sample for filling the sample chamber.

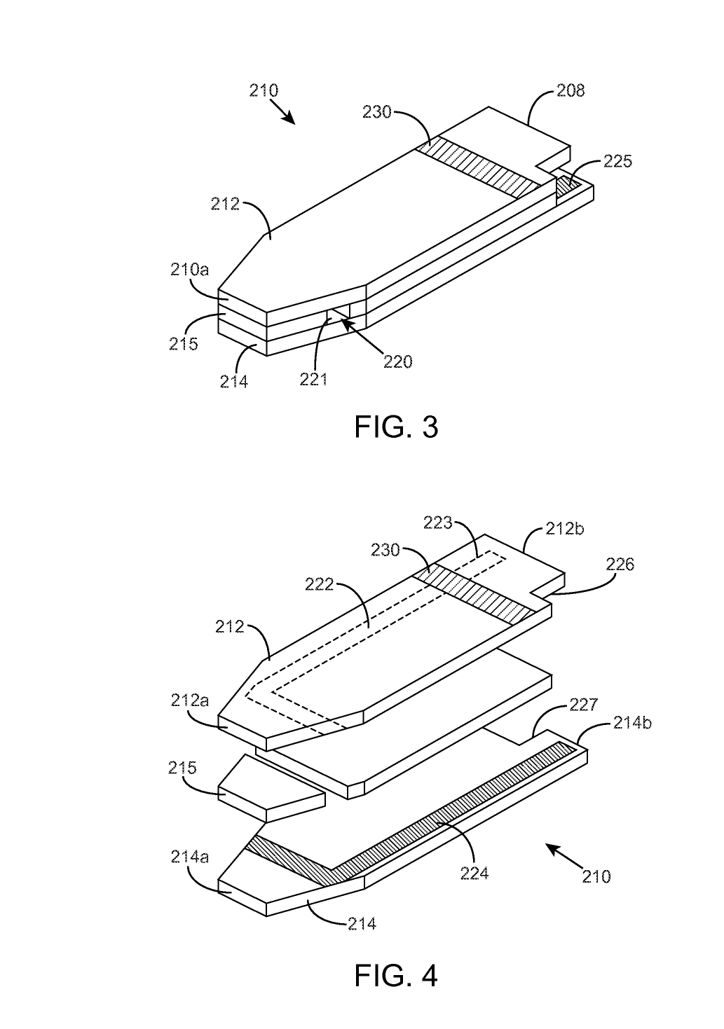

In certain embodiments, the analyte sensor may be an in vitro sensor with electrodes in a facing configuration. Referring to the FIGS. 3 and 4 in particular, a first embodiment of a sensor 210 is schematically illustrated, herein shown in the shape of a strip. Sensor strip 210 has a first substrate 212, a second substrate 214, and a spacer 215 positioned therebetween. Sensor strip 210 includes at least one working electrode 222 and at least one counter electrode 224. Sensor strip 210 also includes an optional insertion monitor 230. The insertion monitor functions to wake-up or turn-on a meter once the sensor is operably connected to the meter. The insertion monitor may provide calibration information to the meter.

The first substrate 212, a second substrate 214, and the spacer 215 define a sample chamber 220 with inlet 221 for ingress of sample.

Sensor strip 210 has a first, proximal end 210A and an opposite, distal end 210B. Near distal end 210A, Sample chamber 220 is present close to the proximal end of sensor 210. Distal end 210B of sensor 210 is configured for operable, and usually releasable, connection to a device such as a meter.

Sensor strip 210 is a layered construction, in certain embodiments having a generally rectangular shape, i.e., its length is longer than its width, although other shapes are possible as well. The length of sensor strip 210 is from end 210A to end 210B.

The counter electrode 224 may be made of a conductive material with a layer of catalyst disposed thereon. As noted above, the counter electrode does not include AgCl.

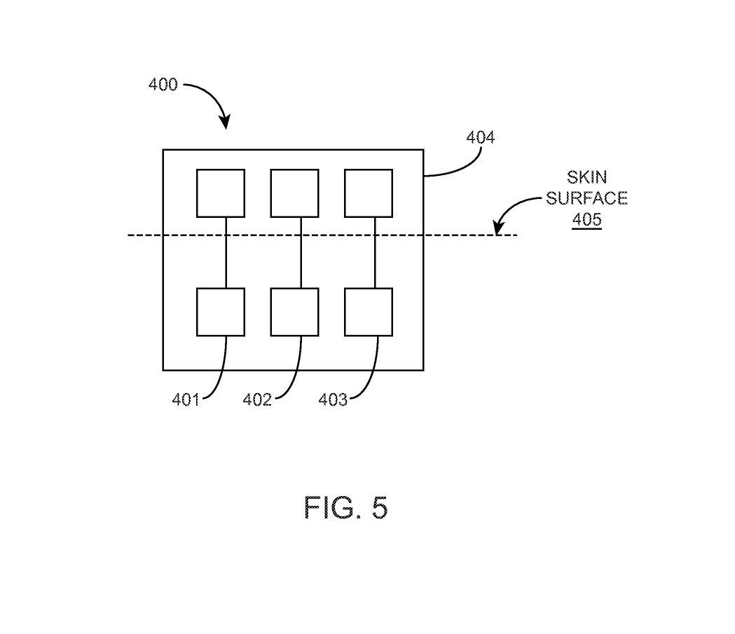

FIG. 5 schematically shows an analyte sensor 400 in accordance with one embodiment of the present disclosure. This sensor embodiment includes electrodes 401, 402 and 403 on a base 404. The analyte sensor 400 may be wholly implantable in a user or may be configured so that only a portion is positioned within (internal) a user and another portion outside (external) a user. For example, the sensor 400 may include a first portion positionable above a surface of the skin 405, and a second portion positioned below the surface of the skin. In such embodiments, the external portion may include contacts (connected to respective electrodes of the second portion by traces) to connect to another device also external to the user such as a transmitter unit. While the embodiment of FIG. 5 shows three electrodes side-by-side on the same surface of base 404, other configurations are contemplated, e.g., fewer or greater electrodes, some or all electrodes on different surfaces of the base or present on another base, some or all electrodes stacked together, electrodes of differing materials and dimensions, etc. Additional sensor configurations are discussed herein and provided in, for example, U.S. Pat. No. 6,175,752, the disclosure of which is incorporated herein by reference in its entirely.

Electrodes (and/or other features) may be applied or otherwise processed using any suitable technology, e.g., chemical vapor deposition (CVD), physical vapor deposition, sputtering, reactive sputtering, printing, coating, ablating (e.g., laser ablation), painting, dip coating, etching, and the like. Materials include, but are not limited to, any one or more of aluminum, carbon (including graphite), cobalt, copper, gallium, gold, indium, iridium, iron, lead, magnesium, mercury (as an amalgam), nickel, niobium, osmium, palladium, platinum, rhenium, rhodium, selenium, silicon (e.g., doped polycrystalline silicon), silver, tantalum, tin, titanium, tungsten, uranium, vanadium, zinc, zirconium, mixtures thereof, and alloys, oxides, or metallic compounds of these elements.

In certain embodiments, the thickness of spacer layer may be constant throughout, and may be at least about 0.01 mm (10 μm) and no greater than about 1 mm or about 0.5 mm. For example, the thickness may be between about 0.02 mm (20 μm) and about 0.2 mm (200 μm). In one certain embodiment, the thickness is about 0.05 mm (50 μm), and about 0.1 mm (100 μm) in another embodiment.

The sample chamber has a volume sufficient to receive a sample of biological fluid therein. In some embodiments, the sample chamber has a volume that is typically no more than about 1 μL, for example no more than about 0.5 μL, and also for example, no more than about 0.3 μL, 0.25 μL, or 0.1 μL.

The sensing layer may include deposited as an aqueous solution of an analyte specific enzyme and a redox mediator. The sensing layer can be screen-printed, deposited using an ink-jet printer, for example. The sensing layer may be disposed in the sample chamber on the working electrode and/or the reference and/or the counter electrode.

A layer of mesh may overlay the electrodes. This layer of mesh may protect the printed components from physical damage. The layer of mesh may also facilitate wetting the electrodes by reducing the surface tension of the sample, thereby allowing it to spread evenly over the electrodes. The mesh layer may be made of a polymer.

Analyte test strips for use with the invention can be of any kind, size, or shape known to those skilled in the art; for example, FREESTYLE® and FREESTYLE LITE™ test strips, as well as PRECISION™ test strips sold by ABBOTT DIABETES CARE Inc. modified to embody the sensor disclosed herein, for example, modified to exclude an electron acceptor (e.g., silver chloride) at the reference electrode or any other electrodes and to include a catalyst for reducing oxygen at the reference or counter or reference/counter electrode.

In addition to the embodiments specifically disclosed herein, the reagents and methods of the present disclosure can be configured to work with a wide variety of analyte test strips, e.g., those disclosed in U.S. patent application Ser. No. 11/461,725, filed Aug. 1, 2006; U.S. Patent Application Publication No. 2007/0095661; U.S. Patent Application Publication No. 2006/0091006; U.S. Patent Application Publication No. 2006/0025662; U.S. Patent Application Publication No. 2008/0267823; U.S. Patent Application Publication No. 2007/0108048; U.S. Patent Application Publication No. 2008/0102441; U.S. Patent Application Publication No. 2008/0066305; U.S. Patent Application Publication No. 2007/0199818; U.S. Patent Application Publication No. 2008/0148873; U.S. Patent Application Publication No. 2007/0068807; U.S. patent application Ser. No. 12/102,374, filed Apr. 14, 2008, and U.S. Patent Application Publication No. 2009/0095625; U.S. Pat. No. 6,616,819; U.S. Pat. No. 6,143,164; U.S. Pat. No. 6,592,745; U.S. Pat. No. 6,071,391 and U.S. Pat. No. 6,893,545; US Patent Application Publication No. US 2007/0272563; U.S. Pat. No. 5,628,890; U.S. Pat. No. 6,764,581; and U.S. Pat. No. 7,311,812, for example, the disclosures of each of which are incorporated by reference herein in their entirety.

Analyte sensors are disclosed in these patent application publication and patents are each herein incorporated by reference in its entirety.

In certain embodiments, the analyte sensor may have additional electrodes, such as, one or more indicator electrodes to indicate whether the sample chamber is sufficiently filled with sample. In certain embodiments the analyte sensor may have a conductive material disposed thereon which conductive material functions to wake-up the meter once the analyte sensor is inserted into a measurement device such as a meter and is operably connected to the measurement device.

The dimensions of the analyte sensor may vary. In certain embodiments, the overall length of analyte sensor may be no less than about 10 mm and no greater than about 50 mm. For example, the length may be between about 30 and 45 mm; e.g., about 30 to 40 mm. It is understood, however that shorter and longer sensor strips could be made. In certain embodiments, the overall width of sensor strip may be no less than about 3 mm and no greater than about 15 mm. For example, the width may be between about 4 and 10 mm, about 5 to 8 mm, or about 5 to 6 mm. In one particular example, sensor strip has a length of about 32 mm and a width of about 6 mm. In another particular example, sensor strip has a length of about 40 mm and a width of about 5 mm. In yet another particular example, sensor strip has a length of about 34 mm and a width of about 5 mm.

Representative examples of analyte specific enzymes that may be present in the sample chamber of the analyte sensors in a sensing layer include glucose dehydrogenase, glucose-6-phosphate dehydrogenase, glucose oxidase, cholesterol oxidase, lactate oxidase β-hydroxybutyrate dehydrogenase, alcohol dehydrogenase, lactate dehydrogenase, formaldehyde dehydrogenase, malate dehydrogenase, and 3-hydroxysteroid dehydrogenase. For example, an enzyme, including a glucose oxidase, glucose dehydrogenase (e.g., pyrroloquinoline quinone (PQQ), dependent glucose dehydrogenase, flavine adenine dinucleotide (FAD) dependent glucose dehydrogenase, or nicotinamide adenine dinucleotide (NAD) dependent glucose dehydrogenase), may be used when the analyte of interest is glucose. A lactate oxidase or lactate dehydrogenase may be used when the analyte of interest is lactate.

Representative examples of redox mediators that may be present in the sample chamber of the analyte sensor, for example, in a sensing layer, include organometallic redox species such as metallocenes including ferrocene or inorganic redox species such as hexacyanoferrate (III), ruthenium hexamine, etc. Additional suitable electron transfer agents usable a redox mediators in the sensors of the present invention are Embodiments may employ electron transfer agents having a redox potential ranging from about −200 mV to about +200 mV versus the standard calomel electrode (SCE).

Additional examples include those described in U.S. Pat. Nos. 6,736,957, 7,501,053 and 7,754,093, the disclosures of each of which are incorporated herein by reference in their entirety.

### Application of the Analyte Sensor

Also provided herein is a method for analyzing an analyte in a sample of body fluid, the method comprising contacting the sample with an analyte sensor, the analyte sensor comprising a first electrode, comprising an enzyme specific for the analyte and a redox mediator; a second electrode, comprising a catalyst for reducing oxygen, wherein the catalyst mediates transfer of electrons from the analyte to oxygen; and analyzing the analyte.

In certain aspects of the invention, the method does not require application of external potential to the analyte sensor in order to analyze the analyte in the sample of body fluid. The catalyst, analyte specific enzyme, and redox mediator included in the sensor are as provided above.

In certain aspects a method for analyzing an analyte in a sample of body fluid is described. The method comprises contacting the sample with an analyte sensor, the analyte sensor comprising a first electrode comprising an enzyme specific for the analyte and a redox mediator; a second electrode, comprising a catalyst for reducing oxygen, wherein the catalyst mediates transfer of electrons from the analyte to oxygen; and oxidizing the analyte via the enzyme; transferring electrons generated from the oxidizing to the first electrode; transferring the electrons to a meter connected to the analyte sensor; transferring the electrons from the meter to the second electrode; transferring the electrons from the second electrode to oxygen via the catalyst present on the second electrode, analyzing the electrons transferred through the meter, thereby analyzing the analyte. The sensor used in the method is described in the preceding sections.

In certain cases, the signal (e.g., current) generated from oxidation of the analyte is increased compared to the signal generated from oxidation of the analyte using a sensor not comprising the catalyst for reducing oxygen. In certain cases, the signal is at least 5%, or 10%, or 15%, or 20%, or 30%, or 40%, or 50%, or 60%, or 70%, or 80%, or 90%, or 100%, or 120%, or 130% higher than the signal generated from oxidation of the analyte using a sensor not comprising the catalyst for reducing oxygen.

In one embodiment, the analyzing step includes determining the concentration of the analyte by amperometry, coulometry, potentiometry, and/or voltametry, including square wave voltammetry.

A common use for an analyte sensor of the present invention, such as analyte sensor 10, 110, 210 is for the determination of analyte concentration in a biological fluid, such as blood, interstitial fluid, and the like, in a patient or other user. Analytes that may be determined include but are not limited to, for example, glucose, acetyl choline, amylase, bilirubin, cholesterol, chorionic gonadotropin, glycosylated hemoglobin (HbAlc), creatine kinase (e.g., CK-MB), creatine, DNA, fructosamine, glucose, glutamine, growth hormones, hormones, ketones, ketone bodies, lactate, peroxide, prostate-specific antigen, prothrombin, RNA, thyroid stimulating hormone, and troponin. In certain cases, the analyte sensor determines the concentration of glucose.

The analyte sensors as disclosed herein may be available at pharmacies, hospitals, clinics, from doctors, and other sources of medical devices. Multiple analyte sensors as disclosed herein may be packaged together and sold as a single unit; e.g., a package of about 25, about 50, or about 100 sensors, or any other suitable number. A kit may include one or more sensors, and additional components such as control solutions and/or lancing device and/or meter, etc.

The analyte sensors may be used for an electrochemical assay, or, for a photometric test. The analyte sensor may be used to provide the concentration of an analyte present in a body fluid sample by using a coulometric technique, a potentiometric technique or an amperometric technique. In certain embodiments, the sensor is connected to an amperometer to detect and provide concentration of an analyte, e.g., glucose. Sensors are generally configured for use with an electrical meter, which may be connectable to various electronics. As mentioned above, the meter may be a coulometer, a potentiometer or an amperometer. A meter may be available at generally the same locations as the sensors, and sometimes may be packaged together with the sensors, e.g., as a kit.

Examples of suitable electronics connectable to the meter include a data processing terminal, such as a personal computer (PC), a portable computer such as a laptop or a handheld device (e.g., personal digital assistants (PDAs)), and the like. The electronics are configured for data communication with the receiver via a wired or a wireless connection. Additionally, the electronics may further be connected to a data network (not shown) for storing, retrieving and updating data corresponding to the detected analyte level (e.g., glucose level) of the user.

The various devices connected to the meter may wirelessly communicate with a server device, e.g., using a common standard such as 802.11 or Bluetooth RF protocol, or an IrDA infrared protocol. The server device could be another portable device, such as a Personal Digital Assistant (PDA) or notebook computer, or a larger device such as a desktop computer, appliance, etc. In some embodiments, the server device has a display, such as a liquid crystal display (LCD), as well as an input device, such as buttons, a keyboard, mouse or touch-screen. With such an arrangement, the user can control the meter indirectly by interacting with the user interface(s) of the server device, which in turn interacts with the meter across a wireless link.

The server device may also communicate with another device, such as for sending data from the meter and/or the service device to a data storage or computer. For example, the service device could send and/or receive instructions (e.g., an insulin pump protocol) from a health care provider computer. Examples of such communications include a PDA synching data with a personal computer (PC), a mobile phone communicating over a cellular network with a computer at the other end, or a household appliance communicating with a computer system at a physician's office.

A lancing device or other mechanism to obtain a sample of biological fluid, e.g., blood, from the patient or user may also be available at generally the same locations as the sensors and the meter, and sometimes may be packaged together with the sensor and/or meter, e.g., as a kit.

The sensors are particularly suited for inclusion in an integrated device, i.e., a device which has the sensor and a second element, such as a meter or a lancing device, in the device. The integrated device may be based on providing an electrochemical assay or a photometric assay. In some embodiments, sensors may be integrated with both a meter and a lancing device. Having multiple elements together in one device reduces the number of devices needed to obtain an analyte level and facilitates the sampling process. For example, embodiments may include a housing that includes one or more of the sensor strips, a skin piercing element and a processor for determining the concentration of an analyte in a sample applied to the strip. A plurality of sensors may be retained in a cassette in the housing interior and, upon actuation by a user, a single sensor may be dispensed from the cassette so that at least a portion extends out of the housing for use.

### Operation of the Analyte Sensor

In use, a sample of biological fluid is provided into the sample chamber of the sensor, where the level of analyte is determined. The analysis may be based on providing an electrochemical assay or a photometric assay. In many embodiments, it is the level of glucose in blood that is determined. Also in many embodiments, the source of the biological fluid is a drop of blood drawn from a patient, e.g., after piercing the patient's skin with a lancing device, which could be present in an integrated device, together with the sensor strip.

Prior to providing the sample to the sensor, or even after providing the sample to the sensor, there may be no need for the user to input a calibration code or other information regarding the operation and/or interaction of the sensor with the meter or other equipment. The sensor may be configured so that the results received from the analysis are clinically accurate, without the user having to adjust the sensor or the meter. The sensor is physically configured to provide accurate results that are repeatable by a batch of sensors.

After receipt of the sample in the sensor, the analyte in the sample is, e.g., electrooxidized or electroreduced, at the working electrode and the level of current obtained at the counter electrode is correlated as analyte concentration. The sensor may be operated with or without applying a potential to the electrodes. In one embodiment, the electrochemical reaction occurs spontaneously and a potential need not be applied between the working electrode and the counter electrode. In another embodiment, a potential is applied between the working electrode and the counter electrode.

### Manufacturing of Analyte Sensor

Analyte sensor or sensor strips discussed above, are sandwiched or layered constructions. In certain embodiments, the analyte sensor may include first and second substrates spaced apart by a spacer layer and optionally including a mesh layer in the sample chamber defined by the first and second substrates and the spacer layer. Such a construction can be made by combining the various layers together in any suitable manner. An alternate method for making sensor strips as described herein is to mold the sensors.

In general, the method of manufacturing sensor strips involves positioning a working electrode and a reference and/or a counter electrode on the first or the second substrates, contacting at least a portion of the working electrode and/or reference and/or counter electrode with a sensing layer composition.

Optionally, providing a mesh in the sample chamber defined by the first and second substrates and the spacer layer.

In certain embodiments, the method of manufacturing the analyte sensor described herein comprises providing a first substrate and a second substrate, the first substrate comprising a first major surface and a second major surface, the second substrate comprising a first major surface and a second major surface; disposing carbon, gold or palladium on the second major surface of the first substrate or the first major surface of the second substrate to form a first electrode; disposing platinum or platinized carbon on the second major surface of the first substrate or the first major surface of the second substrate to form a second electrode in absence of disposing a silver/silver chloride layer on the first or the second substrate; combining the first and second substrates to provide an analyte sensor.

In certain embodiments, the disposing comprises disposing platinized carbon at a density of at least about 4 μg/mm².

In certain cases, the disposing comprises disposing carbon, gold or palladium on the second major surface of the first substrate and disposing platinum or platinized carbon on the first major surface of the second substrate.

In other cases, the disposing comprises disposing carbon, gold or palladium and platinum or platinized carbon on the second major surface of the first substrate.

In certain embodiments, the method comprises disposing a reagent layer comprising glucose oxidase or glucose dehydrogenase and a redox mediator on the first electrode. In certain cases, the glucose dehydrogenase is pyrrole quinoline quinone glucose dehydrogenase or flavin-adenine dinucleotide glucose dehydrogenase.

In certain examples, the method comprises disposing a reagent layer comprising hydroxybutyrate dehydrogenase and a redox mediator on the first electrode.

In certain cases, combining the first and second substrates comprises including a spacer layer of 100 μm thickness between the second major surface of the first substrate and the first major surface of the second substrate.

In certain cases, combining the first and second substrates comprises including a spacer layer of 50 μm thickness between the second major surface of the first substrate and the first major surface of the second substrate.

Disposing of carbon, gold or palladium and platinum or platinized carbon may be performed by chemical vapor deposition (CVD), physical vapor deposition, sputtering, reactive sputtering, printing, coating, ablating (e.g., laser ablation), painting, dip coating, etching, and the like.

Other embodiments and modifications within the scope of the present disclosure will be apparent to those skilled in the relevant art. Various modifications, processes, as well as numerous structures to which the embodiments of the invention may be applicable will be readily apparent to those of skill in the art to which the invention is directed upon review of the specification. Various aspects and features of the invention may have been explained or described in relation to understandings, beliefs, theories, underlying assumptions, and/or working or prophetic examples, although it will be understood that the invention is not bound to any particular understanding, belief, theory, underlying assumption, and/or working or prophetic example. Although various aspects and features of the invention may have been described largely with respect to applications, or more specifically, medical applications, involving diabetic humans, it will be understood that such aspects and features also relate to any of a variety of applications involving non-diabetic humans and any and all other animals. Further, although various aspects and features of the invention may have been described largely with respect to applications involving in vitro disposable single use sensor strips, it will be understood that such aspects and features also relate to any of a variety of sensors that are suitable for use in connection with the body of an animal or a human, such as those suitable for use as partially implanted sensors, such as transcutaneous or subcutaneous sensors or fully implanted in the body of an animal or a human. Finally, although the various aspects and features of the invention have been described with respect to various embodiments and specific examples herein, all of which may be made or carried out conventionally, it will be understood that the invention is entitled to protection within the full scope of the appended claims.

The following examples are put forth so as to provide those of ordinary skill in the art with a complete disclosure and description of how to make and use the embodiments of the invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXAMPLE 1

### Manufacturing of Analyte Sensor

Reagents (a composition of FAD-GDH and MAP mediator) were coated onto the adhesive bearing carbon half of a FREESTYLE® test strip. The MAP mediator has a potential well negative of Ag/AgCl under normal physiological conditions. MAP mediator is an osmium complex with n-methyl pyridine ligand (MAP mediator is described in U.S. Pat. No. 7,615,637, herein incorporated by reference in its entirety and specifically the section of U.S. Pat. No. 7,615,637 describing osmium complex mediators are incorporated by reference herein). It is also substantially negative of the potential developed by Platinum/Carbon (Pt/C) electrode in the presence of oxygen, typically about +200 mV vs. Ag/AgCl. This negative potential of mediator allows the test strip to operate without an applied potential.

A second carbon-coated FREESTYLE® test strip half, without adhesive, was coated with a 4% suspension of 50/50 Pt/C (Platinum loaded carbon powder) in 10% ethanol, 50 mM HEPES (N-(2-Hydroxyethyl) piperazine-N′-(2-ethanesulfonic acid)), 20 mM NaCl (sodium chloride), surfactants Ipegal CO 610 (2 mg/mL) and Pluronic F108 (10 mg/mL). This coating was applied as a stripe of Pt/C, about 3 mm wide, at a deposition rate of 1.2 μL/cm. Three such stripes were applied in succession, one atop another. The resulting coverage of Pt/C was about 4.8 μg/mm².

These two strip halves were then combined to make a two electrode sensor, with a modest mediator loading of about 3 mM. The sensor does not include a Ag/AgCl layer.

In the assembled test strip, the facing electrodes were separated by a distance of about 50 micrometer.

### EXAMPLE 2

### Performance of Analyte Sensor Using Oxygen as Oxidant

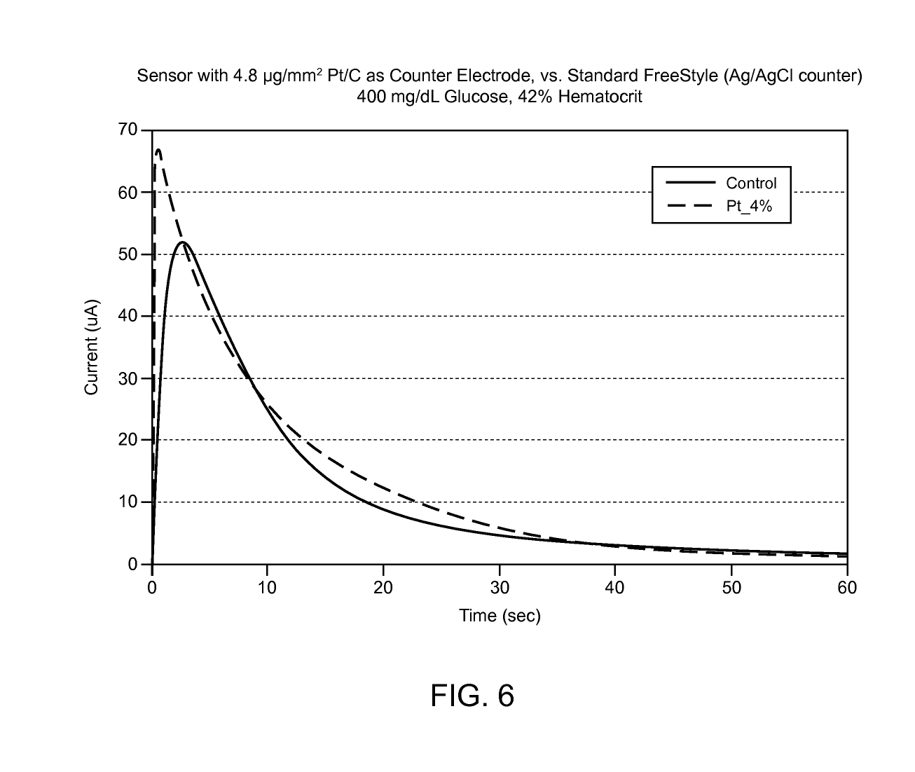

The resulting test strips were tested with spiked blood at various hematocrit concentrations. The applied potential was 0 V, and electrolysis was continued for 60 seconds to effect near total electrolysis of the glucose. Glucose concentration was determined by coulometry. A typical curve obtained by using the sensor to measure a glucose concentration of 400 mg/dL and a hematocrit of 42% is shown in FIG. 6.

Notably, the total charge obtained from electrolysis of 400 mg/dL glucose in an analyte sensor manufactured as described in Example 1 was similar to that obtained from the FREESTYLE® test strip, indicating that sufficient oxygen was available.

It was noted that the availability of oxygen is a function of the thickness (loading density) of the Pt/C layer since insufficiently thick Pt/C does not provide sufficient oxygen to exhaustively oxidize higher concentrations of glucose (data not shown).

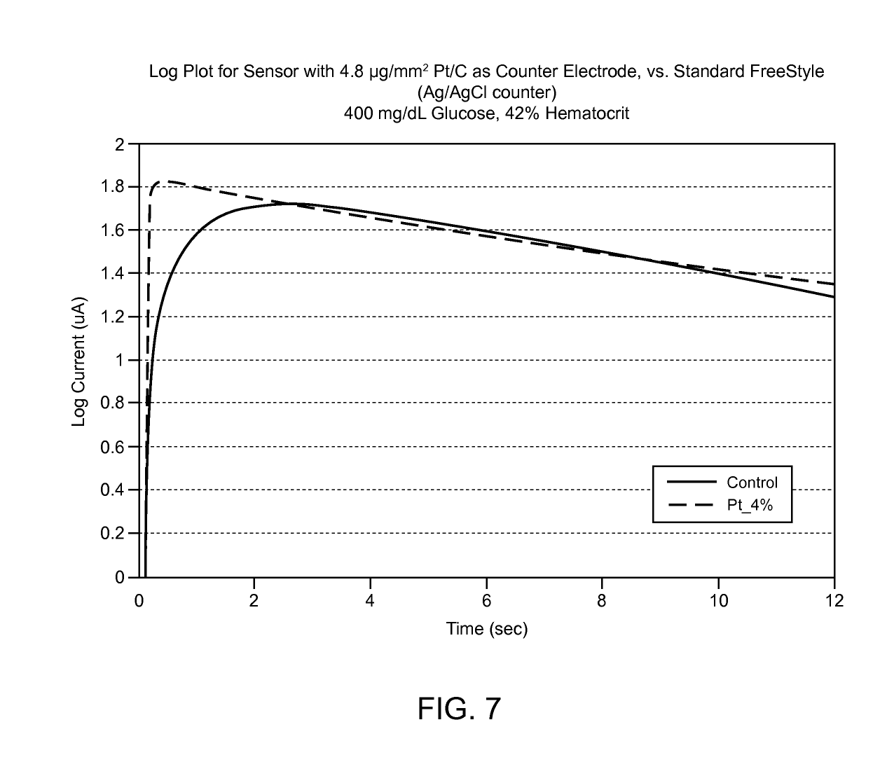

It was also noted that Pt/C containing strips have a higher peak current. Additionally, the Pt/C containing strip filled more rapidly than the standard FREESTYLE® test strip (See FIG. 7). The log current plot depicted in FIG. 7 shows that Pt/C containing strips develop a nearly linear log plot after less than one second. Therefore, Pt/C containing strip can function as ultrafast test strip because the log current plot can be extrapolated to predict the total charge passed as soon as the log plot becomes linear.

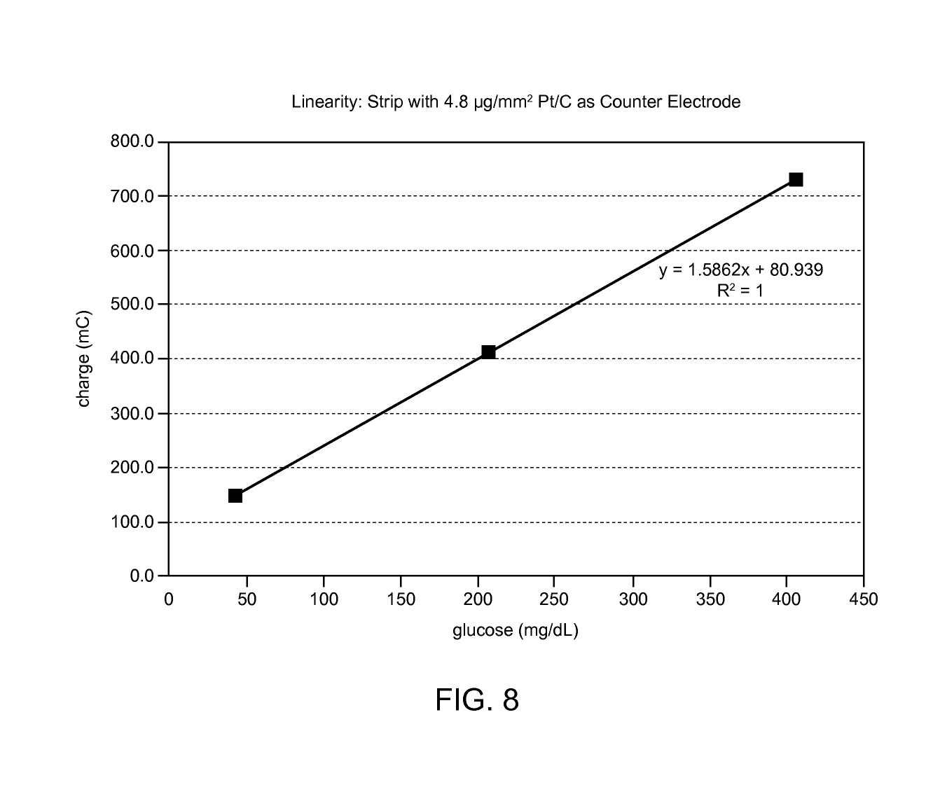

The linearity of the test strip was also tested over a range of glucose concentration (50-400 mg/dL) in spiked blood. As shown in FIG. 8, the graph is linear with a slope (1.5 μC/(mg/dL)) similar to that obtained with the standard FREESTYLE® test strip.

In conclusion, the analyte sensor with Pt/C as a counter electrode offers advantages of low mediator loading while simplifying fabrication. In addition, the analyte sensor with Pt/C as a counter electrode has an ultralow response time.

That which is claimed is:

1. A method of manufacturing an analyte sensor, the method comprising:
providing a first substrate and a second substrate, the first substrate comprising a first major surface and a second major surface, the second substrate comprising a first major surface and a second major surface;
disposing carbon, gold or palladium on the second major surface of the first substrate or the first major surface of the second substrate to form a first electrode;
disposing platinum or platinized carbon on the second major surface of the first substrate or the first major surface of the second substrate to form a second electrode in absence of disposing a silver/silver chloride layer on the first or the second substrate;
combining the first and second substrates to provide an analyte sensor, wherein the platinum is a catalyst for reducing atmospheric oxygen, and wherein the sensor does not include Ag/AgCl,
wherein the catalyst mediates transfer of electrons generated from oxidation of the analyte to atmospheric oxygen.

2. The method of claim 1, wherein the disposing comprises disposing platinized carbon at a density of at least about 4 μg/mm².

3. The method of claim 1, wherein the disposing comprises disposing carbon, gold or palladium on the second major surface of the first substrate and disposing platinum or platinized carbon on the first major surface of the second substrate.

4. The method of claim 1, wherein the disposing comprises disposing carbon, gold or palladium and platinum or platinized carbon on the second major surface of the first substrate.

5. The method of claim 1, wherein the method comprises disposing a reagent layer comprising glucose oxidase or glucose dehydrogenase and a redox mediator on the first electrode.

6. The method of claim 5, wherein the glucose dehydrogenase is pyrrole quinoline quinone glucose dehydrogenase or flavin-adenine dinucleotide glucose dehydrogenase.

7. The method of claim 1, wherein the method comprises disposing a reagent layer comprising hydroxybutyrate dehydrogenase and a redox mediator on the first electrode.

8. The method of claim 1, wherein combining the first and second substrates comprises including a spacer layer of 100 μm thickness between the second major surface of the first substrate and the first major surface of the second substrate.

9. The method of claim 1, wherein combining the first and second substrates comprises including a spacer layer of 50 μm thickness between the second major surface of the first substrate and the first major surface of the second substrate.

10. An analyte sensor for analyzing an analyte, the analyte sensor comprising:
a first electrode consisting of carbon, gold or palladium,
an enzyme specific for the analyte and a redox mediator disposed on the first electrode;
a second electrode consisting essentially of platinum or platinized carbon, wherein the platinum is a catalyst for reducing atmospheric oxygen, and wherein the sensor does not include Ag/AgCl,
wherein the catalyst mediates transfer of electrons generated from oxidation of the analyte to atmospheric oxygen.

11. The analyte sensor of claim 10, wherein the second electrode consists of platinized carbon.

12. The analyte sensor of claim 10, wherein the second electrode consists of platinum.

13. The analyte sensor of claim 10, wherein the redox mediator is an Osmium complex.

14. The analyte sensor of claim 10, wherein the analyte is glucose and the enzyme is glucose oxidase or glucose dehydrogenase.

15. The analyte sensor of claim 14, wherein the glucose dehydrogenase is pyrrole quinoline quinone glucose dehydrogenase or flavin-adenine dinucleotide glucose dehydrogenase.

16. The analyte sensor of claim 10, wherein the analyte is ketone and the enzyme is hydroxybutyrate dehydrogenase.

17. The analyte sensor of claim 10, wherein the first and second electrodes are in a facing configuration and are separated by a distance of about 100 μm.

18. The analyte sensor of claim 10, wherein the first and second electrodes are in a facing configuration and are separated by a distance of about 50 μm.

19. The analyte sensor of claim 10, wherein the second electrode consisting of at least 4 μg/mm² of platinized carbon.
